(19) United States
(12) Patent Application Publication
(10) Pub. No.: US 2024/0078943 A1
(43) Pub. Date: Mar. 7, 2024

(54) TRANSMISSION ABNORMALITY DETECTING CIRCUIT, SOURCE DRIVER, AND TRANSMISSION ABNORMALITY DETECTING METHOD

(71) Applicant: LAPIS Technology Co., Ltd., Yokohama (JP)

(72) Inventor: Kunihiro HARAYAMA, Yokohama (JP)

(73) Assignee: LAPIS Technology Co., Ltd., Yokohama (JP)

(21) Appl. No.: 18/459,430

(22) Filed: Sep. 1, 2023

(30) Foreign Application Priority Data
Sep. 2, 2022 (JP) 2022-139769

(51) Int. Cl. G09G 3/00; G09G 3/20; G09G 3/36

(52) U.S. Cl. CPC G09G 3/006; G09G 3/2092; G09G 3/3688; G09G 3/3696; G09G 2330/12; G09G 2340/02; G09G 2370/00

(57) ABSTRACT

The transmission abnormality detecting circuit provided in a receiving circuit receiving encoded data and configured to detect an abnormality of data transmission between a transmitting circuit and the receiving circuit includes: a decoding circuit configured to decode reception data received by the receiving circuit and to generate decoded data; an encoding circuit configured to encode the decoded data and to generate re-encoded data; and an error detecting circuit configured to detect whether an abnormality has occurred in data transmission between the transmitting circuit and the receiving circuit by comparing the reception data with the re-encoded data.

### CROSS-REFERENCE TO RELATED APPLICATION

This application claims priority under 35 USC 119 from Japanese Patent application No. 2022-139769 filed on Sep. 2, 2022, the disclosure of which is incorporated by reference herein.

### BACKGROUND

### Technical Field

The disclosure relates to a transmission abnormality detecting circuit, a source driver, and a transmission abnormality detecting method.

### Description of Related Art

When data is transmitted from a transmitter unit to a receiver unit in transmission of serial data, adding dummy data to transmission data based on a predetermined rule and transmitting data encoded such that “1” or “0” does not continue for a predetermined period or more is performed to curb deterioration of waveform quality due to attenuation in a transmission line. The receiver unit receives serial data and performs decoding based on a predetermined rule.

A PLL type clocked data recovery circuit is widely used for the receiver unit in transmission of serial data. In the receiver unit including such a PLL type clocked data recovery circuit, PLL synchronization may be lost due to disturbance noise or the like. When PLL synchronization is lost, data cannot be transmitted normally and thus there is a likelihood that the receiver unit will receive erroneous data and operate erroneously. Therefore, a receiving circuit that prevents a reception error by performing a scrambling process using a synchronization code and establishing a synchronized state for a short time even when a transmission error has occurred has been proposed (for example, Japanese Patent Laid-Open No. 2015-144392).

As a means for detecting that PLL synchronization has been lost, a means for determining whether encoded data received by the receiver unit departs from an encoding rule is known. At this time, when overhead dummy data is added to the encoded data, the number of patterns of combinations of transmission data is larger than the number of patterns of combinations of data to be originally transmitted.

For example, the number of combinations of serial data with n-bit data as a bundle is 2n. When k-bit dummy data is added thereto and the resultant data is transmitted, the number of combinations of data received by the receiver unit is 2^{n+k} Accordingly, when the received encoded data has an abnormality, the number of combinations determined to be an error by the receiver unit is 2^{n+k}−2ⁿ=2ⁿ (2^{k}−1), which is larger than the number of combinations of data to be originally transmitted.

Accordingly, there is a problem in that all errors cannot be detected simply by ascertaining the regularity of the received encoded data and the accuracy of error detection is low.

The disclosure provides a transmission abnormality detecting circuit that can detect a transmission abnormality of data with high accuracy.

### SUMMARY

According to an aspect of the disclosure, there is provided a transmission abnormality detecting circuit provided in a receiving circuit receiving encoded data and configured to detect an abnormality of data transmission between a transmitting circuit and the receiving circuit, the transmission abnormality detecting circuit including: a decoding circuit configured to decode reception data received by the receiving circuit and to generate decoded data; an encoding circuit configured to encode the decoded data and to generate re-encoded data; and an error detecting circuit configured to detect whether an abnormality has occurred in data transmission between the transmitting circuit and the receiving circuit by comparing the reception data with the re-encoded data.

According to another aspect of the disclosure, there is provided a source driver detachably connected to a display panel including multiple data lines and configured to drive the data lines based on image data transmitted from a timing controller, the source driver including: a receiver unit configured to receive encoded image data from the timing controller; a decoding circuit configured to decode the image data received by the receiver unit and to generate decoded data; a data latch circuit configured to latch the decoded data; a gradation voltage generator configured to generate a gradation voltage signal for driving the data lines based on the decoded data latched by the data latch circuit; an encoding circuit configured to encode the decoded data and to generate re-encoded data; and an error detecting circuit configured to detect whether an abnormality has occurred in data transmission between the timing controller and the receiver unit by comparing the image data received by the receiver unit with the re-encoded data. The data latch circuit stops latching of the decoded data when the error detecting circuit detects that an abnormality has occurred in data transmission of the image data.

According to yet another aspect of the disclosure, there is provided a transmission abnormality detecting method of detecting an abnormality in data transmission between a transmitting circuit and a receiving circuit which transmit and receive encoded data, the transmission abnormality detecting method including: a step of decoding reception data received by the receiving circuit and generating decoded data; a step of encoding the decoded data and generating re-encoded data; and a step of detecting whether an abnormality has occurred in data transmission between the transmitting circuit and the receiving circuit by comparing the reception data with the re-encoded data.

### BRIEF DESCRIPTION OF THE DRAWINGS

FIG. 1 is a block diagram illustrating a configuration of a transceiver system according to a first embodiment.

FIG. 2 is an extracted block diagram illustrating a part of a transmission abnormality detecting circuit.

FIG. 3 is a diagram illustrating an example of data when a transmission abnormality has occurred.

FIG. 4 is a block diagram illustrating a configuration of a display device according to a second embodiment.

FIG. 5 is a block diagram illustrating an internal configuration of a source driver according to the second embodiment.

FIG. 6 is a block diagram illustrating a configuration of a transceiver system according to the second embodiment.

### DESCRIPTION OF THE EMBODIMENTS

With the transmission abnormality detecting circuit according to the disclosure, it is possible to detect a transmission abnormality of data with high accuracy.

Exemplary embodiments of the disclosure will be described below in detail. In description of the following embodiments and the accompanying drawings, substantially the same or equivalent elements will be referred to by the same reference signs.

### First Embodiment

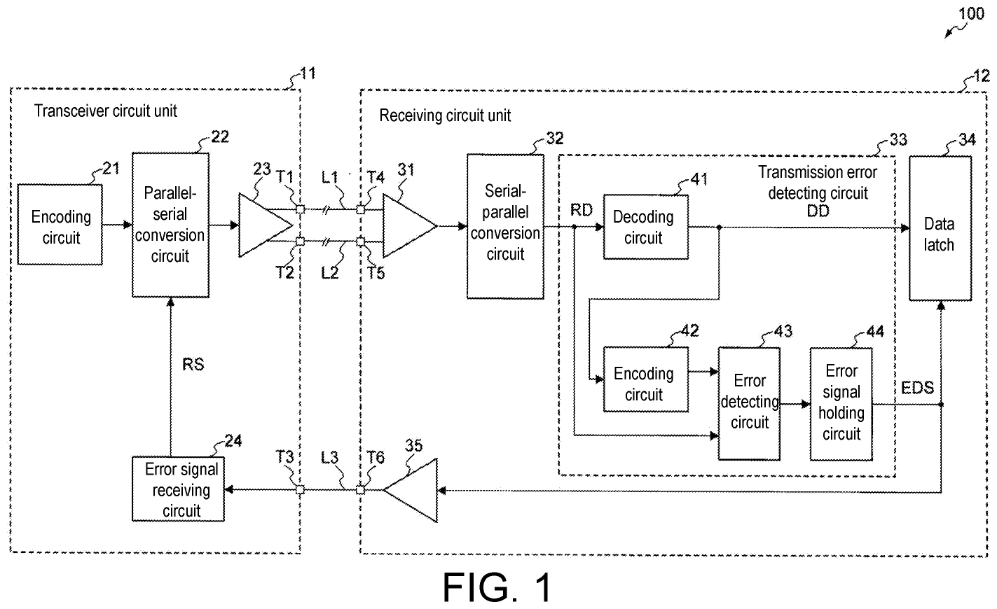

FIG. 1 is a block diagram illustrating a configuration of a transceiver system 100 according to the disclosure. The transceiver system 100 includes a transmitting circuit unit 11 and a receiving circuit unit 12. The transmitting circuit unit 11 and the receiving circuit unit 12 are connected to each other via data transmission lines L1 and L2 for serial communication.

The transmitting circuit unit 11 is a circuit block that performs data transmission by serial communication. The transmitting circuit unit 11 includes an encoding circuit 21, a parallel-serial conversion circuit 22, a transmitter 23, and an error signal receiving circuit 24.

The encoding circuit 21 is a circuit that encodes data to be transmitted according to a predetermined encoding rule. In this embodiment, the encoding circuit 21 encodes n-bit data to be transmitted (hereinafter referred to as transmission target data) and generates (n+k)-bit encoded data to which k-bit dummy data is added (where n and k are integers equal to or greater than 2).

At this time, the encoding circuit 21 encodes the data according to an encoding rule for prohibiting data values from being continuously 1 or 0 in a predetermined period or more. The encoding circuit 21 supplies the encoded data to the parallel-serial conversion circuit 22.

The parallel-serial conversion circuit 22 is a circuit configured to convert parallel data to serial data. In this embodiment, the parallel-serial conversion circuit 22 performs parallel-serial conversion on the data encoded by the encoding circuit 21 and generates serial transmission data. The parallel-serial conversion circuit 22 supplies the generated serial transmission data to the transmitter 23. The parallel-serial conversion circuit 22 is configured to be supplied with a reception notification RS from the error signal receiving circuit 24 and to stop the parallel-serial conversion operation in response thereto.

The transmitter 23 is a signal transmitting unit configured to output serial data generated in the inside of the transmitting circuit unit 11 to the outside of the transmitting circuit unit 11. The transmitter 23 is connected to the data transmission lines L1 and L2 via external terminals T1 and T2 provided in the transmitting circuit unit 11. The transmitter 23 transmits serial transmission data supplied from the parallel-serial conversion circuit 22 to the data transmission lines L1 and L2.

The error signal receiving circuit 24 is connected to a data transmission line L3 via an external terminal T3 provided in the transmitting circuit unit 11. The error signal receiving circuit 24 receives an error detection signal EDS indicating that a transmission error has been detected in the receiving circuit unit 12 from the receiving circuit unit 12 via the data transmission line L3. The error signal receiving circuit 24 supplies a reception notification RS indicating that an error detection signal EDS has been received to the parallel-serial conversion circuit 22.

In this embodiment, when the error detection signal EDS indicates that an error has occurred (for example, a logic level is 1), the error signal receiving circuit 24 supplies the reception notification RS with logic level 1 indicating that to the parallel-serial conversion circuit 22.

The receiving circuit unit 12 is a circuit block that performs data transmission with the transmitting circuit unit 11 by serial communication. The receiving circuit unit 12 includes a transmitter 31, a serial-parallel conversion circuit 32, a transmission abnormality detecting circuit 33, a data latch 34, and an error signal output circuit 35.

The transmitter 31 is connected to the data transmission lines L1 and L2 via external terminals T4 and T5 provided in the receiving circuit unit 12. The transmitter 31 receives serial transmission data transmitted via the data transmission lines L1 and L2 and supplies the received data as serial reception data to the serial-parallel conversion circuit 32.

The serial-parallel conversion circuit 32 performs serial-parallel conversion on the serial reception data supplied from the transmitter 31 and generates parallel reception data. The serial-parallel conversion circuit 32 supplies the generated parallel reception data to the transmission abnormality detecting circuit 33.

The transmission abnormality detecting circuit 33 is a circuit configured to detect whether a transmission abnormality has occurred in data transmission between the transmitting circuit unit 11 and the receiving circuit unit 12 based on the parallel reception data supplied from the serial-parallel conversion circuit 32. The transmission abnormality detecting circuit 33 includes a decoding circuit 41, an encoding circuit 42, an error detecting circuit 43, and an error signal holding circuit 44.

The decoding circuit 41 is a circuit configured to perform a decoding process on encoded data. In this embodiment, the decoding circuit 41 performs a decoding process on parallel reception data generated by the serial-parallel conversion circuit 32. The decoding circuit 41 supplies the reception data DD subjected to the decoding process to the data latch 34 and the encoding circuit 42.

The encoding circuit 42 is a circuit configured to perform an encoding process on data. In this embodiment, the encoding circuit 42 performs a process of encoding data temporarily decoded by the decoding circuit 41 again (hereinafter referred to as a re-encoding process). At that time, the encoding circuit 42 performs the re-encoding process based on the same encoding rule as that for encoding performed by the encoding circuit 21 of the transmitting circuit unit 11. The encoding circuit 42 supplies data subjected to the re-encoding process to the error detecting circuit 43.

The error detecting circuit 43 detects whether an error has occurred by comparing the data subjected to the decoding process by the decoding circuit 41 and the re-encoding process by the encoding circuit 42 with the reception data subjected to parallel conversion and output from the serial-parallel conversion circuit 32. Specifically, when the reception data and the re-encoded data do not match, the error detecting circuit 43 detects that a transmission error has occurred. The error detecting circuit 43 outputs an error detection signal with logic level 0 when a transmission error has not been detected and with a logic level 1 when a transmission error has been detected.

In this embodiment, a delay circuit (for example, a buffer circuit) which is not illustrated is provided between the serial-parallel conversion circuit 32 and the error detecting circuit 43 such that data which is compared by the error detecting circuit 43 to detect a transmission error is corresponding data. That is, timing adjustment is performed such that data subjected to the decoding process by the decoding circuit 41 and the re-encoding process by the encoding circuit 42 and the reception data corresponding to that data are supplied to the error detecting circuit 43 at the same timing.

The error signal holding circuit 44 is a circuit configured to hold a detection result, that is, an error detection signal EDS, output from the error detecting circuit 43 and to appropriately output the error detection signal EDS. The error detection signal EDS output from the error signal holding circuit 44 is supplied to the data latch 34 and the error signal output circuit 35. The error signal holding circuit 44 holds and outputs the error detection signal EDS based on a clock timing of a clock signal which is not illustrated.

The data latch 34 receives reception data DD subjected to the decoding process and supplied from the decoding circuit 41. In this embodiment, the data latch 34 is configured to switch between reception of data and stopping of reception based on the error detection signal EDS supplied from the error signal holding circuit 44. Specifically, when the error detection signal EDS has logic level 0, that is, when a transmission error has not been detected, the data latch 34 receives the reception data DD subjected to the decoding process and supplied from the decoding circuit 41. On the other hand, when the error detection signal EDS has logic level 1, that is, when a transmission error has been detected, the data latch 34 stops reception of the reception data DD subjected to the decoding process.

The error signal output circuit 35 is connected to the data transmission line L3 via an external terminal T6 provided in the receiving circuit unit 12. The error signal output circuit 35 outputs the error detection signal EDS supplied from the error signal holding circuit 44 to the data transmission line L3. The error detection signal EDS is supplied to the error signal receiving circuit 24 of the transmitting circuit unit 11 via the data transmission line L3. Accordingly, the transmitting circuit unit 11 is notified that a transmission error has occurred.

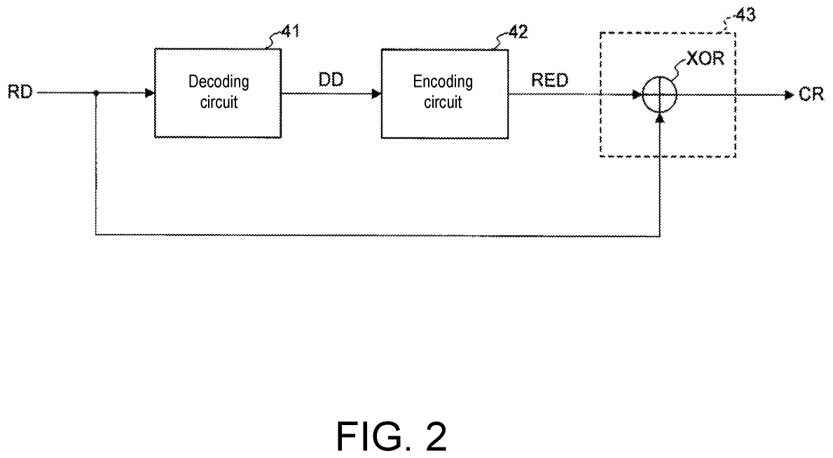

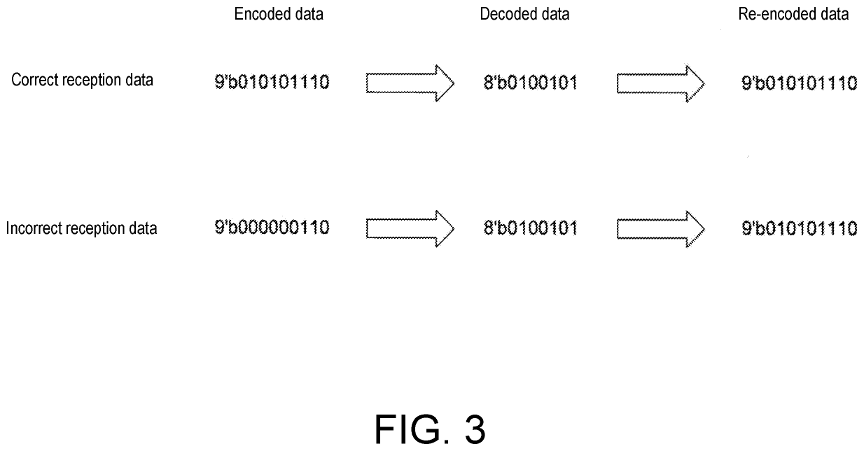

An error detecting operation of the error detecting circuit 43 will be described below with reference to FIGS. 2 and 3.

FIG. 2 is an extracted diagram illustrating the decoding circuit 41, the encoding circuit 42, and the error detecting circuit 43.

The error detecting circuit 43 is constituted by an exclusive-OR circuit XOR. The error detecting circuit 43 outputs an exclusive OR of reception data RD and re-encoded data RED obtained by performing the decoding process by the decoding circuit 41 and the re-encoding process by the encoding circuit 42 on the reception data RD as a comparison result.

FIG. 3 is a diagram illustrating an example of decoded data (data on which a decoding process has been performed by the decoding circuit 41) and re-encoded data (data on which a re-encoding process has been performed by the encoding circuit 42) in both a case in which a transmission abnormality has not occurred and correct reception data RD has been acquired and a case in which a transmission abnormality has occurred and incorrect reception data RD has been acquired.

When a transmission error has not occurred and correct reception data RD has been acquired, for example, data which has not been yet input to the decoding circuit 41 (hereinafter referred to as encoded data) is “9′b010101110,” data subjected to the decoding process by the decoding circuit 41 (hereinafter referred to as decoded data) is “8′b0100101,” and data subjected to the re-encoding process by the encoding circuit 42 (hereinafter referred to as re-encoded data) is “9′b010101110.”

When a transmission error has not occurred in this way, the encoded data and the re-encoded data match. Accordingly, the error detecting circuit 43 outputs an error detection signal EDS with logic level 0.

On the other hand, when a transmission error has occurred and incorrect reception data RD has been acquired, for example, the encoded data is “9′b000000110,” the decoded data is “8′b0100101,” and the re-encoded data is “9′b010101110.”

When a transmission error has occurred in this way, the encoded data and the re-encoded data do not match. Accordingly, the error detecting circuit 43 outputs an error detection signal EDS with logic level 1.

As described above, the transmission abnormality detecting circuit 33 according to this embodiment includes the decoding circuit 41 configured to decode reception data, the encoding circuit 42 configured to re-encode the data decoded by the decoding circuit 41, and the error detecting circuit 43 configured to detect whether an error has occurred by comparing the non-decoded data (the encoded data) with the re-encoded data.

With the transmission abnormality detecting circuit 33 according to this embodiment, since occurrence of a transmission error can be detected by simply comparing the non-decoded reception data with the re-encoded reception data, it is possible to accurately detect a transmission abnormality of data with a simple configuration.

Unlike the transmission abnormality detecting circuit 33 according to this embodiment, with a method of determining whether a transmission error has occurred in consideration of regularity of encoded data which is non-decoded reception data, there are many combinations of data and thus all errors cannot be detected when dummy data is added to the reception data.

That is, the number of combinations of serial data with data of n bits (for example, 8 bits) as a bundle is 2′. When dummy data of k bits (for example, 1 bit) is added to the data and the resultant is transmitted, the number of combinations of data received by the receiver unit is 2^{n+k} Accordingly, when an abnormality has occurred in the received encoded data, the number of combinations which are erroneous by the receiver unit is 2^{N+k}−2ⁿ=2ⁿ(2^{k}−1), which is larger than the number of combinations of data to be originally transmitted. As a result, it is not possible to detect all errors by only considering regularity of the received encoded data.

On the other hand, since the transmission abnormality detecting circuit 33 according to this embodiment performs comparison of data using the XOR circuit and detects occurrence of an error based on matching/mismatching thereof, it is possible to detect all errors even when dummy data is added thereto.

### Second Embodiment

A second embodiment of the disclosure will be described below. A transmission abnormality detecting circuit according to this embodiment is provided inside of a source driver of a display device.

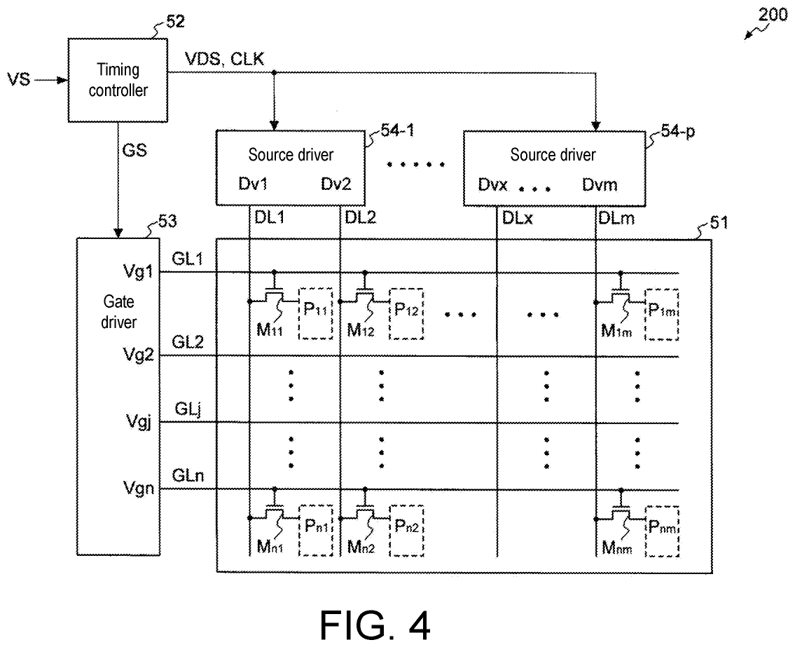

FIG. 4 is a block diagram illustrating a configuration of a display device 200 in which the transmission abnormality detecting circuit according to this embodiment is provided.

The display device 200 is an active matrix-driven liquid crystal display device. The display device 200 includes a display panel 51, a timing controller 52, a gate driver 53, and source drivers 54-1 to 54-p.

The display panel 51 is constituted by a semiconductor substrate in which a plurality of pixel units P11 to Pnm and pixel switches M11 to Mnm (where n is an integer equal to or greater than 2 and m is an integer equal to or greater than 2 and a multiple of 3) are arranged in a matrix shape of n rows×m columns. The display panel 51 includes n gate lines GL1 to GLn which are horizontal scanning lines and m data lines DL1 to DLm which are arranged to perpendicularly cross the gate lines. The pixel units P11 to Pnm and the pixel switches M11 to Mnm are provided at crossed parts of the gate lines GL1 to GLn and the data lines DL1 to DLm and are arranged in a matrix shape.

Turning-on/off of the pixel switches M11 to Mnm is controlled in accordance with gate signals Vg1 to Vgn supplied from the gate driver 53. The pixel units P11 to Pnm are supplied with gradation voltage signals DV1 to DVm corresponding to image data from the source drivers 54-1 to 54-p. When the pixel switches M11 to Mnm are in the ON state, the gradation voltage signals DV1 to DVm are applied to pixel electrodes of the pixel units P11 to Pnm and thus the pixel electrodes are charged. Luminance of the pixel units P11 to Pnm is controlled in accordance with the gradation voltage signals DV1 to DVm of the pixel electrodes of the pixel units P11 to Pnm, and display is performed.

In other words, m pixel units arranged in an extending direction of the gate lines (that is, one horizontal line) are selected as supply targets of the gradation voltage signals DV1 to DVm through operating of the gate driver 53. The source drivers 54-1 to 54-p apply the gradation voltage signals DV1 to DVm to the selected pixel units in one horizontal line to display colors corresponding to the voltages. By repeating an extending direction of the data lines (that is, in the vertical direction) while selectively switching the pixel units in one horizontal line selected as the supply targets of the gradation voltage signals DV1 to DVm, a screen corresponding to one frame is displayed.

In this embodiment, the gate driver 53 scans the gate lines GL1 to GLn (that is, supplies the gate signals Vg1 to Vgn) in a direction in which they are separated from the gate driver 53 from a position closest to the gate driver 53. The gate driver 53 sequentially selects the gate lines as the supply targets of the gate signals Vg1 to Vgn in a direction from the gate line GL1 to the gate line GLn (that is, a direction from the gate line closest to the source drivers 54-1 to 54-p to the gate line farthest therefrom). Accordingly, the gradation voltage signals Dv are sequentially applied to the pixel electrodes of the pixel units P11 to Pnm in the direction from the position closest to the gate driver 53 to the position farthest therefrom in the extending direction of the gate lines and in the direction from the position closest to the source drivers 54-1 to 54-p to the position farthest therefrom in the extending direction of the data lines, and a screen corresponding to one frame is displayed.

In the pixel units P11 to Pnm, every three neighboring pixel units (that is, the pixel units of 3 ch) out of m pixel units arranged in the extending direction of the gate lines correspond to three pixels of red (R), green (G), and blue (B). That is, when j=(1/3)m, 1 ch, 4 ch, . . . , (3j−2) ch correspond to “R,” 2 ch, 5 ch, . . . , (3j−1) ch correspond to “G,” and 3 ch, 6 ch, . . . , 3j ch correspond to “B.” For example, one color is expressed by a combination of R, G, and B of 1 ch, 2 ch, and 3 ch.

Each of the pixel units P11 to Pnm includes a transparent electrode connected to the corresponding data line via the pixel switch and liquid crystal sealed between a semiconductor substrate and a counter substrate which is provided to face the semiconductor substrate and in which one transparent electrode is formed on the whole surface thereof. Regarding a backlight in the display device, transmittance of the liquid crystal changes according to a voltage difference between the gradation voltage signals DV1 to DVm supplied to the pixel units P11 to Pnm and the voltage of the counter substrate, whereby display is performed.

The timing controller 52 generates an image data signal VDS including a sequence of pixel data pieces PD representing luminance levels of the pixels, for example, using 256 luminance gradations of 8 bits based on an image signal VS. The image data signal VDS includes image data signals serialized according to the number of transmission paths for every predetermined number of data lines.

The timing controller 52 generates a clock signal CLK in an embedded clock system with a fixed clock cycle. The timing controller 52 supplies the clock signal CLK to the source drivers 54-1 to 54-p as a serial signal integrated with the image data signal VDS.

The gate driver 53 is supplied with a gate control signal GS from the timing controller 52 and sequentially supplies the gate signals Vg1 to Vgn to the gate lines GL1 to GLn based on a clock timing included in the gate control signal GS.

The source drivers 54-1 to 54-p are formed as a driver integrated circuit (IC) provided for every data lines corresponding to the number into which the data lines DL1 to DLm are grouped according to a resolution of the display panel 51. The source drivers 54-1 to 54-p are arranged in the extending direction of the gate lines and constitute a source driver group including source drivers in a first stage to a p-th stage (hereinafter also referred to as a final stage) with respect to the scanning direction.

Each of the source drivers 54-1 to 54-p has a source output of channels (hereinafter referred to as ch) corresponding to the number of data lines which are driven thereby. Each source output corresponds to three pixels of red (R), green (G), and blue (B) every 3 ch.

The source drivers 54-1 to 54-p receive pixel data pieces PD corresponding to one horizontal scanning line (that is, corresponding to the number of chs corresponding to the source drivers of the pixel data pieces PD for one horizontal scanning line) included in the image data signal VDS supplied from the timing controller 52 and generates gradation voltage signals DV1 to DVm corresponding to luminance gradations indicated by the received pixel data pieces PD. Then, the source drivers 54-1 to 54-p apply the generated gradation voltage signals DV1 to DVm as the source outputs to the data lines DL1 to DLm of the display panel 51.

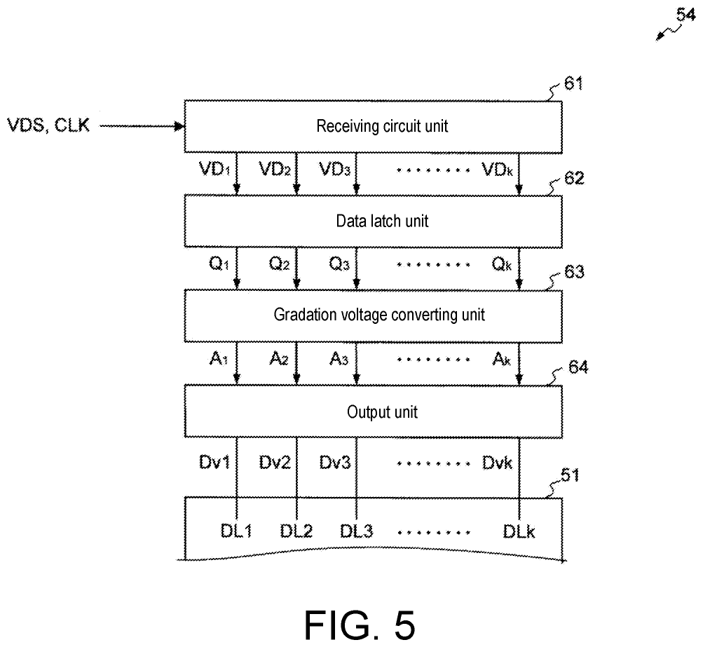

FIG. 5 is a block diagram illustrating an internal configuration of one of the source drivers 54-1 to 54-p (hereinafter referred to as a source driver 54). The source driver 54 includes a receiving circuit unit 61, a data latch unit 62, a gradation voltage converting unit 63, and an output unit 64.

The receiving circuit unit 61 receives an image data signal VDS transmitted from the timing controller 52 and supplies image data included in the image data signal VDS as image data VD1 to VDk corresponding to the number of output chs (for example, k chs) of the source driver 54 to the data latch unit 62.

The data latch unit 62 sequentially receives the image data VD1 to VDk supplied from the receiving circuit unit 61. The data latch unit 62 outputs the received image data VD1 to VDk as pixel data Q1 to Qk to the gradation voltage converting unit 63. The data latch unit 62 includes k output ends corresponding to k data lines driven by the source driver 54 and outputs the pixel data Q1 to Qk from the k output ends.

The gradation voltage converting unit 63 converts the pixel data Q1 to Qk supplied from the data latch unit 62 to positive or negative gradation voltages A1 to Ak with voltage values corresponding to the luminance gradations indicated by the pixel data and supplies the resultant voltages to the output unit 64.

The output unit 64 generates gradation voltage signals DV1 to DVk by amplifying the gradation voltages A1 to Ak and supplies the generated gradation voltage signals to the data lines DL1 to DLk.

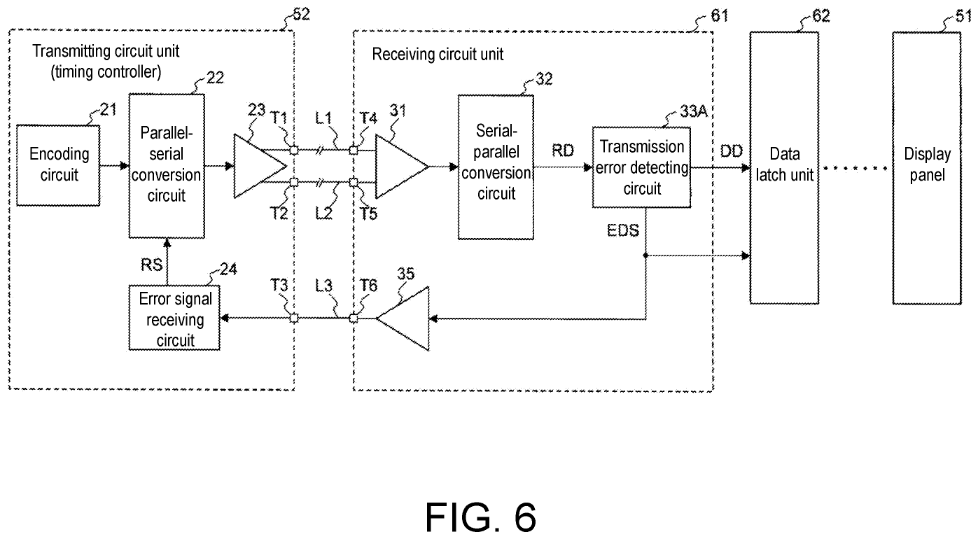

FIG. 6 is a block diagram illustrating the configuration of the receiving circuit unit 61 according to this embodiment. Only a part corresponding to a transmitting circuit unit is extracted from the internal configuration of the timing controller 52 and illustrated.

The timing controller 52 includes a constituent part corresponding to the transmitting circuit unit according to the first embodiment. That is, the timing controller 52 includes an encoding circuit 21, a parallel-serial conversion circuit 22, a transmitter 23, and an error signal receiving circuit 24. These functions and operations are the same as in the first embodiment and thus description thereof will be omitted.

The receiving circuit unit 61 includes a transmitter 31, a serial-parallel conversion circuit 32, a transmission abnormality detecting circuit 33A, and an error signal output circuit 35. The transmission abnormality detecting circuit 33A has the same configuration as the transmission abnormality detecting circuit 33A according to the first embodiment. That is, the transmission abnormality detecting circuit 33 includes a decoding circuit 41, an encoding circuit 42, an error detecting circuit 43, and an error signal holding circuit 44.

The transmission abnormality detecting circuit 33A supplies reception data DD subjected to a decoding process by the decoding circuit 41 to the data latch unit 62. The transmission abnormality detecting circuit 33A supplies an error detection signal EDS which is generated based on a comparison result between the non-decoded reception data and the reception data subjected to the re-encoding process to the data latch unit 62.

The data latch unit 62 sequentially receives the decoded reception data DD supplied from the receiving circuit unit 61 as image data VD1 to VDk. At that time, the data latch unit 62 receives the image data VD1 to VDk when the error detection signal EDS has logic level 0 and stops receiving of the image data VD1 to VDk when the error detection signal EDS has logic level 1.

The error detection signal EDS output from the transmission abnormality detecting circuit 33A is output to the data transmission line L3 by the error signal output circuit 35 and is supplied to the timing controller 52. The timing controller 52 can stop data transmission to the source driver 54, for example, when a transmission error has occurred based on the error detection signal EDS.

As described above, according to this embodiment, the transmission abnormality detecting circuit 33A is provided in each of the source drivers 54-1 to 54-p of the display device 200. Similarly to the transmission abnormality detecting circuit 33 according to the first embodiment, the transmission abnormality detecting circuit 33A detects a transmission error by comparing the non-decoded reception data with the decoded and re-encoded reception data. When a transmission error is detected, receiving of data in the data latch unit 62, that is, update of data latch, is stopped.

With the display device having the aforementioned configuration, it is possible to prevent an erroneous operation such as display based on incorrect data when an error occurs in data transmission between the timing controller 52 and the source drivers 54-1 to 54-p.

The disclosure is not limited to the aforementioned embodiments. For example, the second embodiment describes an example in which the transmission abnormality detecting circuit is provided in the source driver of the display device and a transmission error in data transmission between the timing controller and the source driver is detected. However, the disclosure is not limited thereto, and the transmission abnormality detecting circuit according to the disclosure can be applied to various devices transmitting encoded data.

The data sequence described in the first embodiment is an example, and the number of bits of data transmitted between the transmitting circuit unit 11 and the receiving circuit unit 12, the encoding rule, and the like are not limited to those described in the first embodiment.

What is claimed is:

1. A transmission abnormality detecting circuit provided in a receiving circuit receiving encoded data and configured to detect an abnormality of data transmission between a transmitting circuit and the receiving circuit, the transmission abnormality detecting circuit comprising:
a decoding circuit configured to decode reception data received by the receiving circuit and to generate decoded data;
an encoding circuit configured to encode the decoded data and to generate re-encoded data; and
an error detecting circuit configured to detect whether an abnormality has occurred in data transmission between the transmitting circuit and the receiving circuit by comparing the reception data with the re-encoded data.

2. The transmission abnormality detecting circuit according to claim 1, wherein the error detecting circuit detects that the abnormality has occurred in data transmission when the reception data and the re-encoded data do not match.

3. The transmission abnormality detecting circuit according to claim 2, further comprising a data latch circuit configured to latch the decoded data,
wherein the error detecting circuit supplies an error detection signal indicating a detection result of whether the abnormality has occurred in data transmission to the data latch circuit, and
wherein the data latch circuit stops latching of the decoded data when the error detection signal indicates that the abnormality has occurred in data transmission.

4. The transmission abnormality detecting circuit according to claim 2, further comprising an error detection signal output circuit configured to transmit an error detection signal to the transmitting circuit.

5. The transmission abnormality detecting circuit according to claim 1, wherein the receiving circuit receives serial data from the transmitting circuit, and
wherein the decoding circuit generates the decoded data by decoding data obtained by performing serial-parallel conversion on the serial data received by the receiving circuit as the reception data.

6. The transmission abnormality detecting circuit according to claim 1, wherein the receiving circuit receives encoded data obtained by encoding n-bit data into (n+k)-bit data, where n and k are integers equal to or greater than 2, from the transmitting circuit, and
wherein the decoding circuit generates the decoded data by decoding the encoded data as the reception data into n-bit data.

7. A source driver detachably connected to a display panel including a plurality of data lines and configured to drive the plurality of data lines based on image data transmitted from a timing controller, the source driver comprising:
a receiver unit configured to receive encoded image data from the timing controller;
a decoding circuit configured to decode the image data received by the receiver unit and to generate decoded data;
a data latch circuit configured to latch the decoded data;
a gradation voltage generator configured to generate a gradation voltage signal for driving the plurality of data lines based on the decoded data latched by the data latch circuit;
an encoding circuit configured to encode the decoded data and to generate re-encoded data; and
an error detecting circuit configured to detect whether an abnormality has occurred in data transmission between the timing controller and the receiver unit by comparing the image data received by the receiver unit with the re-encoded data,
wherein the data latch circuit stops latching of the decoded data when the error detecting circuit detects that the abnormality has occurred in data transmission of the image data.

8. A transmission abnormality detecting method of detecting an abnormality in data transmission between a transmitting circuit and a receiving circuit which transmit and receive encoded data, the transmission abnormality detecting method comprising:
a step of decoding reception data received by the receiving circuit and generating decoded data;
a step of encoding the decoded data and generating re-encoded data; and
a step of detecting whether an abnormality has occurred in data transmission between the transmitting circuit and the receiving circuit by comparing the reception data with the re-encoded data.
